(19) United States
(12) Patent Application Publication
(10) Pub. No.: US 2022/0298313 A1
(43) Pub. Date: Sep. 22, 2022

(54) RETICULATED COMPOSITE MATERIAL

(71) Applicant: Arkema Inc., King of Prussia (FR)

(72) Inventors: Ramin AMIN-SANAYEI, King of Prussia, PA (US); Jeremie BREZUN, Marseille (FR); Mark AUBART, King of Prussia, PA (US); Christian COLLETTE, Antony (FR)

(21) Appl. No.: 17/617,068

(22) PCT Filed: Jun. 18, 2020
(86) PCT No.: PCT/US2020/038388

§ 371 Date: Dec. 7, 2021

Related U.S. Application Data
(60) Provisional application No. 62/863,470, filed on Jun. 19, 2019.

(51) Int. Cl. C08J 5/18; C08J 9/28; C08K 3/22; C08K 3/04; C08K 3/36; H01M 50/446; H01M 50/403; H01M 50/491

(52) U.S. Cl. CPC C08J 5/18; C08J 9/283; C08K 3/22; C08K 3/04; C08K 3/36; H01M 50/446; H01M 50/403; H01M 50/491; C08J 2327/16; C08J 2333/12; C08J 2333/02; C08J 2301/28; C08J 2309/06; C08K 2003/2296; C08K 2003/2227; C08K 2201/011; C08K 2201/001; C08K 2201/006; C08J 2201/0502; C08J 2205/044

(57) ABSTRACT

This invention discloses a reticulated film composite and a method of fabricating the reticulated film composite suitable as a separator in electrochemical cells as sound absorbing films, or as high efficiency filtering media. The reticulated film composite is produced by casting and drying of a slurry which exhibits a high yield stress (i.e. greater than 50 dyne/cm2) and comprised of a high MW resin dissolved in a solvent (i.e. having solution viscosity of higher than 100 cp at 5% in NMP or in water at room temperature) and dispersed nanoparticles with high specific surface areas (i.e. greater than 10 m2/g) such as fumed alumina, or fumed silica, or fumed zirconia or mixture thereof. This reticulated film composite exhibits superior cycling properties and high ionic conductivity with a porosity up to 80% while maintains a high dimensional stability (i.e. less than 10% shrinking) at elevated temperatures (up to 140° C.). The reticulated composite separator coating can be used in combination with an electrode coating either in two separate process steps, or in a one-step process by having a simulations multi-layer casting of electrode and separator to manufacture a lithium ion battery.

### FIELD OF THE INVENTION

This invention discloses a method of fabricating a reticulated (porous, open matrix structure) film composite suitable as a separator in electrochemical devices, as a sound absorbing coating, or as high efficiency filtering media.

### BACKGROUND

Lithium batteries, including lithium metal batteries, lithium ion batteries, lithium polymer batteries, and lithium ion polymer batteries have made tremendous progress in the last two decades and are now driving the demand for cell phones, laptop computers, and electrically operated tools, and more importantly for electrification of vehicle worldwide. However, the safety aspect of such batteries have increasingly become of concern because could lead to fire and an explosive destruction.

Current lithium ion batteries typically use polyolefin-based separators, either uncoated or coated with aluminum oxide or ceramic particles, in order to improve heat stability, and to prevent a short circuit between a cathode and an anode. The polyolefin-based separators are porous and electronically insulator. Further, because such polyolefin-based separators do not adhere well to the electrodes and have a melting point of 140° C. or less, they may shrink melt when the temperature of a battery is increased by internal and/or external factors, and can short-circuit. The short circuit can lead to accidents, such as explosion or fire in a battery, caused by the emission of electric energy. Moreover, polyolefin separators are susceptible to oxidation at above 4.25 V, which in turn shorten the calendar life of battery. As a result, it is necessary to provide a separator that does not undergo heat shrinking at high temperature, adheres well to the electrodes, and electrochemically is stable.

Separators are porous elements, generally in a thin film form. Known from the prior art, there are separators which are applied as a coating directly to the anode and/or cathode (US2015340676), and also self-supporting separators, which are made separately and not as a coating onto the electrodes, but integrated as individual component in the battery (U.S. Pat. No. 8,409,746). U.S. Pat. Nos. 9,799,917 and 9,548,167 also teach separator coatings.

The separator requirements are strenuous such as a very low thickness, effective electronic insulation, high ion transport, high tensile strength, stretch-ability to accommodate volume changes in electrodes, electrochemical stability, high porosity, chemical and mechanical resistance, and more importantly dimensional stability even at elevated temperatures to ensure higher safety factor of batteries.

Separators are often made of melt processable plastics, which are either solution cast or extruded to form films and then stretched to generate 30-60% porosity within the film. Today's common separators are generally based on polypropylene (melting point about 160-165° C.), polyethylene (melting point about 110-135° C.) or blends thereof. For example, U.S. Pat. Nos. 4,620,956 and 5,691,047 describe melt extrusion and stretch process to make polyolefin separators, and U.S. Pat. Nos. 8,064,194 and 8,012,799 disclose solution cast process for producing polyolefin separators. Also known are porous separators made of poly-vinylidene fluoride, PVDF, (melting temperature about 165-170° C.) disclosed in the US patent applications 2009/0208832 and 2010/0183907. A serious drawback of such separators is their low dimensional stabilities at elevated temperature or lack of thermal robustness, which may lead to shrinkage and result in short circuit within cell. Therefore, they are not deemed inherently safe.

There are known separators based on nonwovens such as inorganic nonwovens made from glass or ceramic materials, or organic nonwovens such as cellulose poly-acrylonitrile, polyamides, polyethylene terephthalate, and/or engineering resins (U.S. Pat. Nos. 8,936,878 and 9,412,986). These separators, while being temperature-stable, are often electrochemically and mechanically not sound, thereby shortening the lifetime of corresponding batteries. Moreover, the high thickness of nonwoven separators limits the power and energy density of cells which are often sought after in many applications.

The essential function of the separator in Li-ion batteries is to prevent electronic shorting between electrodes while allowing the electrolyte to pass through and transport ions. The separator plays an important role in the battery's safety, durability, and discharge performance. Today, polyolefin (PE/PP) based microporous membranes are the most widely used separators due to their low cost relative to existing alternatives. For high end applications such as vehicles, the trend is to use ceramic coated polyolefin membranes due to their improved safety and long life.

There are several major drawbacks to conventional polyolefin separators. Their wettability by conventional electrolytes is poor, and as a result, longer times are required for electrolyte filling step during cell fabrication. More importantly, polyolefin separators shrink by pulling back from the cell's edges at elevated temperatures, which allow direct contact between the cathode and the anode. The resulting short circuits can cause fires and explosions. Another drawback is the low chemical stability (oxidation resistance at the cathode side) of polyolefin in a Li-ion environment, especially at high voltages. It has demonstrated polyethylene separators are readily oxidized at 4.25V, which leads to inferior cycle performance.

PVDF and ceramic coated separators have been shown to address the disadvantages of polyolefin separators. For example, U.S. Pat. Nos. 8,168,332 and 9,017,878 and have disclosed an inorganic layer with PVDF binder is used to coat polyolefin separators to improve dimensional stability at elevated temperatures, and electrolyte wettability. Although the coated separators have higher dimensional stability, it is not possible to prevent separator shrinkage at elevated temperature since the separator still contains a polyolefin based substrate. In addition, casting a microporous inorganic layer over a polyolefin based separator increases the separator thickness by approximately two fold which has negative impact on cell capacity and power density.

### Sound Deadening Coating:

The concept of soundproof coating has been around for long time to prevent sound travelling through a wall or to reduce echo in a room as well. Soundproof coating or paint is also known as acoustic paint, insulated paint, sound deadening, and sound dampening paint. Sound dampening coating becomes more attractive when it can reduce the background noise, such as conversational speech, and can be applied simply as a coating on the walls.

The jet engines are the main sources of noise in an aircraft cabin, but jet engines are far too hot for materials typically used for sound deadening such as polymer foams. One possibility for reducing aircraft engine noise is to coat the engine housing with sound insulation and extremely heat-resistant materials to reduce noise in aircraft cabin. The best practice today is to use regular polymer foams as a template from which to create heat-resistant sound-suppressing superalloy metallic foams. The slurry of nickel-based superalloy is coated on to a polymer foam, and then the polymer is burnt off to leave behind an open-cell metallic foam with the same structure as the original polymer. However, this technique is very costly and impractical to coat jet engine housing. Moreover, to achieve a good sound deadening coating, it is needed to control the template replication process, so that a tunable gradient of pore sizes can be achieved within a single foam block which makes process very costly and complicated.

### Filtration Media:

High efficiency filters is a device composed of fibrous or porous materials, which removes solid particulates such as dust, and pollen from the air. They are used in applications where air quality is important, notably in building ventilation systems and in engines. Some systems use foam, pleated paper, or spun fiberglass filter elements. However, these media have physical limitation on removing submicron particulates from air. There are High Efficiency Particulate Air Filters, HEPA filters, which trap air contaminants in a complex web of fibers. The shortcoming of web fiber technology is production of consistent submicron diameters fibers.

### BRIEF DESCRIPTION OF THE FIGURES

FIG. 1 High-resolution SEM picture of 50/50 weigh fractions of PVDF/Al₂O₃ after drying in 120 C oven for 30 minutes. The coating was cast from slurry in NMP which had 5.7% solids.

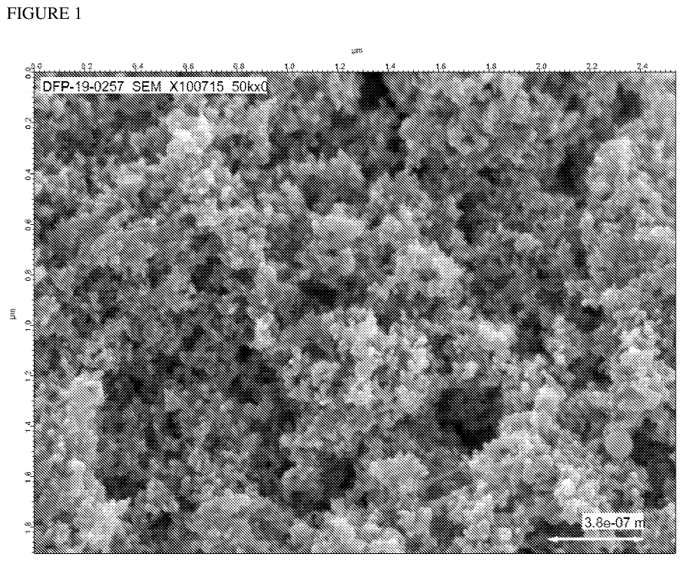

### DESCRIPTION OF THE INVENTION

Copolymer” is used to mean a polymer having two or more different monomer units. “Polymer” is used to include homopolymer and copolymers. Resin and polymer are used interchangeably. The polymers may be homogeneous, heterogeneous, and may have a gradient distribution of co-monomer units. All references cited are incorporated herein by reference. As used herein, unless otherwise described, percent shall mean weight percent. Crystallinity and melting temperature are measure by DSC as described in ASTM D3418 at heating rate of 10 C/min. Melt viscosity is measured in accordance with ASTM D3835 at 230° C. expressed in kPoise @100 Sec-1. Dilute solution viscosity and reduced viscosity of polymers is measured as described in ASTM D2857 at room temperature.

By reticulated film or coating we mean a film or coating with a porous open matrix structure. “Open” means the pores are not enclosed. Fluids can moves between pores. The void fraction or porosity can be measured by compressing the matrix, or by density measurement, or by filling the void with a liquid and measuring the change in density. Preferably the voids (porosity) are measured by density.

Nano sized filler or nano size particles means that the filler or particle size is less than 1 micron, preferably less than 500 nm preferably less than 200 nanometers. The nano size particles can be less than 100 nm. Particles size is volume average particles size as measured by light scattering. (such as a Nicom, or Microtech instrument).

By high specific surface area particles means that the surface area of the particles is greater than 1 m²/g, preferably greater than 5 m²/g, more preferably greater than 10 m²/g. Preferably between 1 m²/g and 1000 m²/g, more preferably between 1 m²/g and 700 m²/g, and even more preferably between 10 m²/g and 500 m²/g. The surface area of the particles can be between 5 and 700 m²/g. Some high specific surface area particles have 3 dimensional branching structures, this can be referred to as a fractal shape which can result in particles with large aspect ratios. Fractal shape are aggregates of primary particles that have 3 dimensional branching.

By high molecular weight means having solution viscosity of at least 100 cp measured at 5% in NMP at room temperature (25° C.), preferably between 100 cp and 10,000 cp, more preferably between 100 cp and 5000 cp or having reduced viscosity, Rv of at least 0.2 dl/g upto 2 dl/g.

Yield stress is the minimum shear stress required to initiate flow in a fluid. A high yield stress is at least 50 dyne/cm² preferably greater than 100 dyne/cm2, greater than 125 dyne/cm2. The yield stress can be up to 5000 dyne/cm2, preferably up to 3000 dyne/cm2. In addition, the slurry must be castable meaning the solution viscosity of the slurry is less than 20,000 cP at room temperature, preferably less than 10,000 cp.

PVDF has been found to be useful as a binder or coating for separators in non-aqueous electrolytic devices because of its excellent electro-chemical resistance and superb adhesion among fluoropolymers. The separator forms a barrier between the anode and the cathode in the battery to prevent electronic shorts while allowing high ionic transportation.

The invention provides for a reticulated film composite with nano sized pores and a method of making the reticulated film composite with nano sized pores. Nanosized pores have an average pore size of less than 500 nm, preferably from 2 nm to 500 nm. The invention also provides for a separator coating in a battery made from the reticulated film composite with nano sized pores.

The reticulated film composites can be produced with different type of resins and wide variety of nano-size particles; particularly with particles that have a fractal shape structures such as fumed alumina, fumed silica, and such that are made of aggregates of primary particles.

The reticulated film composite is made by combining high specific surface area particles and high molecular resins in solvent at room temperature (25° C.) resulting in a slurry that exhibits a high yield stress (greater than 50 dyne/cm²) even at low solid content (i.e. total solids less than 30 weight %, preferably less than 20 wt %, more preferably less than 12% or even less than 10%). Casting the slurry and drying at elevated temperatures thereby forming a reticulated film composite with nano sized pores.

Surprisingly, it was found that a slurry of a high specific surface area nano size particles (for example, fumed alumina, or fumed silica, or ceramics) and a high molecular weight resins, (for example, high MW-PVDF (having solution viscosity of greater than 100 cp at 5% in NMP at room temperature), or high MW-PMMA (having reduced viscosity, Rv of greater than 0.5 dl/g using ASTM D2857 at ambient temperature), which are made in NMP can exhibit high yield stress (greater than 50 dyne/cm²) even at low solid content (i.e. total solids less than 30 weight %, preferably less than 20 wt %, more preferably less than 12% or even less than 10%). When this high yield stress slurry was cast and dried at elevated temperatures, (i.e. 50 to 180° C., preferably above 120° C.), a reticulated film composite with a nano sized pores was formed.

In one embodiment of the invention, high molecular weight PVDF (with solution viscosity of greater than 100 cp at 5% in NMP at room temperature) which is semi-crystalline was used in the invention.

High molecular weight resin like PMMA (with reduced viscosity, Rv, of greater than 0.5 dl/g), and also high MW PAA (with solution viscosity of from 100 and up to 10000 cp, preferably up to 5000 in water at pH 7 at room temperature) can be used to obtain a high yield stress slurry (greater than 50 dyne/cm²), and ultimately produce the reticulated film composites of similar properties to reticulated film made with PVDF.

The filler type generally used in the invention are metal oxides and/or ceramics. The filler type are used in the invention include, for example, insolating fillers include, but not limited to alumina, silica, BaTiO₃, CaO, ZnO, bohemite, TiO₂, SiC, ZrO₂, boron silicate, BaSO₄, nano-clays, Pb(Zr,Ti)O₃, Pb₁₋ₓ LaₓZr_{y}O₃ (0<x<1, 0<y<1), PBMg₃Nb_{2/3})₃, PbTiO₃, hafnia (HfO (HfO₂), SrTiO₃, SnO₂, CeO₂, MgO, NiO, Y₂O₃, Al₂O₃, SiO₂, or mixtures thereof.

Also, useful organic filler are chopped fibers, include, but not limited to aramid fillers and fibers, polyetherether ketone fibers, polyetherketone ketone fibers, PTFE fibers, and nanofibers, carbon nano-tubes, and mixture thereof.

The resin should have a high solution viscosity, i.e. higher than 100 cp at 5% in NMP at room temperature. Preferably, the solution viscosity is between 100 and 10,000 cp, more preferably between 100 and 5000 cp measured at 5% solids in NMP at room temperature. For water soluble polymers the solution viscosity is from 100 cp to 10000 cp, preferably between 100 cp and 5000 cp measured in water at 2% and pH of 7 at room temperature (25° C.). In some instances, the pH can affect the solution viscosity. For this application, the pH can vary from 2 to 12 depending on polymer type and application.

Polymers (resins) useful in the invention include but not limited to homopolymers and copolymers of polyvinylidene (PVDF), poly ethylene-tetrafluoride ethylene (PETFE), polyvinyl fluoride (PVF), poly (alkyl)acrylates, poly (alkyl)methacrylates, poly styrene, poly vinyl alcohol (PVOH), polyesters, polyamides, poly acrylonitrile, poly acrylamide, carboxymethyl cellulose CMC, polyacrylic acids (PAA), polymethacrylic acid (PMAA). Other useful polymers include polyether ketone ketone, polyether ether ketone, and polyesters.

### Polyvinylidene Fluoride

In a preferred embodiment, the polymer is a polyvinylidene fluoride homopolymer or copolymer. The term “vinylidene fluoride polymer” (PVDF) used herein includes both normally high molecular weight homopolymers, copolymers, and terpolymers within its meaning. Copolymers of PVDF are particularly preferred, as they are softer—having a lower Tm, melting point and a reduced crystalline structure. Such copolymers include vinylidene fluoride copolymerized with at least one comonomer. Most preferred copolymers and terpolymers of the invention are those in which vinylidene fluoride units comprise at least 50 mole percent, at least 70 mole percent preferably at least 75 mole %, more preferably at least 80 mole %, and even more preferably at least 85 mole % of the total weight of all the monomer units in the polymer.

Copolymers, terpolymers and higher polymers of vinylidene fluoride may be made by reacting vinylidene fluoride with one or more monomers from the group consisting of vinyl fluoride, trifluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene. In some preferred embodiments the comonomer is selected from the group consisting of tetrafluoroethylene, trifluoroethylene, chlorotrifluoroethylene, hexafluoropropene, vinyl fluoride, pentafluoropropene, tetrafluoropropene, perfluoromethyl vinyl ether, perfluoropropyl vinyl ether.

Particularly preferred are copolymers composed of from at least about 75 and up to 90 mole percent vinylidene fluoride, and correspondingly from 10 to 25 mole percent hexafluoropropene. Terpolymers of vinylidene fluoride, hexafluoropropene and tetrafluoroethylene are also representatives of the class of vinylidene fluoride copolymers, embodied herein.

In one embodiment, up to 50%, preferably up to 20%, and more preferably up to 15%, by weight of hexafluoropropene (HFP) units and 50%, preferably 80%, and more preferably 85%, by weight or more of VDF units are present in the vinylidene fluoride polymer. It is desired that the HFP units be distributed as homogeneously as possible to provide PVDF-HFP copolymer with excellent dimensional stability in an end-use environment—such as in a battery.

The copolymer of PVDF for use in the separator coating composition preferably has a high molecular weight as measured by melt viscosity. By high molecular weight is meant PVDF having a melt viscosity of greater than 10 kilopoise, preferably greater than 20 kilopoise, according to ASTM method D-3835 measured at 232 C and 100 sec-1.

Fluoropolymers such as polyvinylidene-based polymers are made by any process known in the art. Processes such as emulsion and suspension polymerization are preferred and are described in U.S. Pat. No. 6,187,885, and EP0120524.

### Synthetic Polyamides

A polyamide is a polymer (substance composed of long, multiple-unit molecules) in which the repeating units in the molecular chain are linked together by amide groups. Amide groups have the general chemical formula CO—NH. They may be produced by the interaction of an amine (NH₂) group and a carboxyl (CO₂H) group, or they may be formed by the polymerization of amino acids or amino-acid derivatives (whose molecules contain both amino and carboxyl groups).

The synthesis of polyamides is well described in the art, examples are WO15/071604, WO14179034, EP0550308, EP0550315, U.S. Pat. No. 9,637,595.

Polyamides can be condensation or ring opening products:
of one or more amino acids, such as aminocaproic, 7-aminoheptanoic, 11-aminoundecanoic and 12-aminododecanoic acid, or of one or more lactams such as caprolactam, oenantholactam and lauryllactam; with
of one or more salts or mixtures of diamines such as hexamethylenediamine, dodecamethylenediamine, meta-xylylenediamine, bis(p-aminocyclohexyl)methane and trimethylhexamethylenediamine with diacids such as isophthalic, terephthalic, adipic, azelaic, suberic, sebacic and dodecanedicarboxylic acid.

Examples of polyamides can include PA 6, PA 7, PA 8, PA9, PA 10, PA11, and PA 12 and copolyamides like PA 6,6.

The copolyamides can be from the condensation of at least two alpha, omega-amino carboxylic acids or of two lactams or of one lactam and one alpha,omega-amino carboxylic acid. The copolyamides can be from the condensation of at least one alpha,omega-amino carboxylic acid (or one lactam), at least one diamine and at least one dicarboxylic acid.

Examples of lactams include those having 3 to 12 carbon atoms on the main ring, which lactams may be substituted. For example, of β,β-dimethylpropiolactam, α,α-dimethyl-propiolactam, amylolactam, caprolactam, capryllactam and lauryllactam.

Examples of alpha,omega-amino carboxylic acids include aminoundecanoic acid and aminododecanoic acid. Examples of dicarboxylic acids include adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids having a dimer content of at least 98% and preferably being hydrogenated) and dodecanedioic acid, HOOC—(CH2)10-COOH.

The diamine can be an aliphatic diamine having 6 to 12 carbon atoms; it may be of aryl and/or saturated cyclic type. Examples include hexamethylenediamine, piperazine, tetra-methylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4-aminocyclohexyl)methane (BMACM).

Examples of copolyamides include copolymers of caprolactam and lauryllactam (PA 6/12), copolymers of caprolactam, adipic acid and hexamethylenediamine (PA 6/6-6), copolymers of caprolactam, lauryllactam, adipic acid and hexamethylenediamine (PA 6/12/6-6), copolymers of caprolactam, lauryllactam, 11-aminoundecanoic acid, azelaic acid and hexamethylenediamine (PA 6/6-9/11/12), copolymers of caprolactam, lauryllactam, 11-amino-undecanoic acid, adipic acid and hexamethylenediamine (PA 6/6-6/11/12), and copolymers of lauryllactam, azelaic acid and hexamethylenediamine (PA 6-9/12).

Polyamides also include polyamide block copolymers, such as polyether-b-polyamide and polyester-b-polyamide.

Another polyamide is Arkema's ORGASOL® ultra-fine polyamide 6, 12, and 6/12 powders, which are microporous, and have open cells due to their manufacturing process. These powders have a very narrow particle size range that can be between 5 and 60 microns, depending on the grade. Lower average particle sizes of 5 to 20 are preferred.

### Acrylic

Acrylic polymers as used herein is meant to include polymers, copolymers and terpolymers formed from methacrylate and acrylate monomers, and mixtures thereof. The methacrylate monomer and acrylate monomers may make up from 51 to 100 percent of the monomer mixture, and there may be 0 to 49 percent of other ethylenically unsaturated monomers, included but not limited to, styrene, alpha methyl styrene, acrylonitrile. Suitable acrylate and methacrylate monomers and comonomers include, but are not limited to, methyl acrylate, ethyl acrylate and ethyl methacrylate, butyl acrylate and butyl methacrylate, iso-octyl methacrylate and acrylate, lauryl acrylate and lauryl methacrylate, stearyl acrylate and stearyl methacrylate, isobornyl acrylate and methacrylate, methoxy ethyl acrylate and methacrylate, 2-ethoxy ethyl acrylate and methacrylate, dimethylamino ethyl acrylate and methacrylate monomers. (Meth) acrylic acids such as methacrylic acid and acrylic acid can be comonomers. Acrylic polymers include multilayer acrylic polymers such as core-shell structures typically made by emulsion polymerization.

### Styrene

Styrenic polymers as used herein is meant to include polymers, copolymers and terpolymers formed from styrene and alpha methyl styrene monomers, and mixtures thereof. The styrene and alpha methyl styrene monomers may make up from 50 to 100 percent of the monomer mixture, and there may be 0 to 50 percent of other ethylenically unsaturated monomers, including but not limited to acrylates, methacrylates, acrylonitrile. Styrene polymers include, but are not limited to, polystyrene, acrylonitrile-styrene-acrylate (ASA) copolymers, styrene acrylonitrile (SAN) copolymers, styrene-butadiene copolymers such as styrene butadiene rubber (SBR), methyl methacrylate-butadiene-styrene (MBS), and styrene-(meth)acrylate copolymers such as styrene-methyl methacrylate copolymers (S/MMA).

Polyolefin as used herein is meant to include polyethyene, polypropylene, and copolymers of ethylene and propylene. The ethylene and propylene monomers may make up from 51 to 100 percent of the monomer mixture, and there may be 0 to 49 percent of other ethylenically unsaturated monomers, including but not limited to acrylates, methacrylates, acrylonitrile, anhydrides. Examples of polyolefin include ethylene ethylacetate copolymers (EVA), ethylene (meth)acrylate copolymers, ethylene anhydride copolymers and grafted polymers, propylene (meth)acrylate copolymers, propylene anhydride copolymers and grafted polymers.

The solvents useful in the invention to make the slurry include, but are not limited to water, N-methyl-2-pyrrolidone (NMP), toluene, tetrahydrofuran (THF), acetone and hydrocarbons. In preferred embodiments, the solvent is NMP, water, or acetone. The solvent must be able to dissolve the polymer used providing a visibly clear solution. For example, PVDF is soluble in NMP. PVDF is not soluble in water and therefore water would not be used for PVDF. Poly vinyl alcohol (PVOH), poly acrylamide, carboxymethyl cellulose CMC, Polyacrylic acids (PAA), and their copolymers are generally soluble in water.

Other Additives:

The coating composition of the invention may further contain effective amounts of other additives, including but not limited to fillers, leveling agents, anti-foaming agents, pH buffers, and other adjutants typically used in formulation while meeting desired separator requirements.

In a slurry coating composition of the invention, could further optionally have wetting agents, thickeners or rheology modifiers.

Wetting agents could be present in the coating composition slurry at 0 to 5 parts, or 0.1 to 5 parts preferably from 0 to 3 parts, or 0.1 to 3 parts of one or more wetting agents per 100 parts of solvent (parts are by weight). Surfactants can serve as wetting agents, but wetting agents may also include non-surfactants. In some embodiments, the wetting agent can be an organic solvent. The presence of optional wetting agents permits uniform dispersion of powdery material(s) into the slurry. Useful wetting agents include, but are not limited to, ionic and non-ionic surfactants such as the TRITON series (from Dow) and the PLURONIC series (from BASF), BYK-346 (from BYK Additives) and organic liquids that are compatible with the solvent, including but not limited to NMP, DMSO, and acetone.

Thickeners and/or rheology modifiers may be present in the coating composition at from 0 to 10 parts, preferably from 0 to 5 parts of one or more thickeners or rheology modifiers per 100 parts of water (parts by weight). Addition of thickener or rheology modifier to the above dispersion prevents or slows down the settling of powdery materials while providing appropriate slurry viscosity for a casting process. In addition to organic rheology modifiers, inorganic rheology modifiers can also be used alone or in combination.

The total solid content and ratio of resin to nano particle filler should be so chosen that provides a high yield stress slurry, i.e. higher than 50 dyne/cm², preferably greater than 75 dyne/cm2 even more preferably greater than 100 dyne/cm2 or even greater than 200 dyne/cm2. The yield stress can be up to 5000 dyne/cm2, preferably up to 3000 dyne/cm2.

The solids content of the slurry can be from 2 weight percent to 30 weight percent solids, preferably from 2 to 20 weight %, even more preferably from 2 to 12%, or 2 to 10 weight % (based on weight of polymer plus weight of nanoparticles).

The filler has high specific surface area good disperse-ability in the solvent and preferably are fractal shape structures.

Several factors can affect the porosity or density of the reticulated film composites such as reducing solids in the slurry (i.e. from 10% to 6%) yields a few percent higher porosity, a higher drying temperature (i.e. 180° C. instead of 100° C.) increases porosity by few percent, a higher MW resin produces a higher porosity, a higher surface area filler makes a higher porosity. All these tunable properties can be applied to produce a reticulated film composite with a desired properties for a specific application.

### Applications:

The reticulated film composite of this invention can be used as a separator in a electrochemical device, as a sound adsorbing coating, as a filter media or in a high efficiency particulate adsorbing filter such as a HEPA filter.

One application of a reticulated film composite of PVDF made using nanoparticles (Examples include fumed alumina, fumed silica, or fumed zirconia) and having a porosity of 20 to 80%, preferably 25 to 75% is to be used as separator in lithium ion battery or any other types of electrochemical devices to increase safety and enhance, performance, and reduce cost of fabrication. The reticulated film composite not only does not shrink at elevated temperatures but also will expand at hot spots inside the battery to further isolate runaway electrodes from each other. The response to temperature can be tuned with resin composition, For example varying the amount of HFP comonomer in PVDF resin because a reticulated film composite made of a higher HFP (i.e. 20% HFP) content resin will swell/expand at lower temperature relative to those with lower HFP (i.e. 8% HFP) content which may require a higher temperature to obtain the same swelling/expansion. Preferred weight percent of HFP in a copolymer of VDF is from 1 to 25 wt %). Another advantage of reticulated film composite is that can be simultaneously cast with electrodes, i.e. using a double slot die casting machine to cast two slurry layers (active electrode, and separator layers) at the same time onto the current collector using wet-on-wet technique. An integrated electrode and separator structure is subsequently formed during the drying and calendaring steps. For multilayer composite structures, like electrode separators in an electrochemical device or filter media, can be cast wet on wet. When using the wet-on-wet technique the two layers become intertwined with no abrupt interfaces resulting in better adhesion. The reticulated film or coating can be cast simultaneously with and directly onto a substrate in a one step wet on wet process.

Both sound deadening and high efficiency filtration can benefit from the disclosed invention because the coating of this invention can work in sound deadening applications or in a high efficiency filtering media. A number of factors including the following will determine the exact absorption and filtration profile of a porous open-cell coating: cell size; tortuosity; porosity; coating thickness and coating density. Surprisingly we found that pore size of the coating can be changed by changing the aspect ratio of dispersant, by the extent of mixing to de-aggregate dispersant, by changing the phase ratio of binder or dispersant, by changing the total solids in slurry, and by changing the shear stress of the slurry using polymer of different solution viscosities.

More importantly, the flex modulus of binder can be reduced by making softer and less ridged copolymers which in turn can adsorb vibration and act as a more efficient sound deadening coating.

Alternatively, if the polymer is mostly made of PVDF, it could build high electrostatic charge as a filtration media because PVDF has low electrostatic dissipation characteristic. As results it can adsorb submicron particle such as viruses which otherwise could pass thought the pores. Another advantage of disclosed filtering media is high solvent resistance; therefore, can be frequently washed/rinsed with solvents without any lasting detrimental effect.

### Separator

In a preferred embodiment, the composition of the invention can withstand the harsh environment within the battery or any other electrochemical devices and can be readily processed into a coating. When coated onto an electrode the coating acts as a separator without the need for a separate separator base. The separator coating contains electrochemically stable nano size inorganic particles. Preferably, the nano sized particles make up the largest volume percent of the separator coating composition. The nano sized particles provide mechanical stability to the separator. The particles could be spherical or fractal shape structure, but are more often irregular in shape.

The inorganic particles in the coating composition permit an interstitial volume to be formed among them, thereby serving to form micropores and to maintain the physical shape as a spacer. Additionally, because the inorganic particles are characterized in that their physical properties are not changed even at a high temperature of 200° C. or higher, the coated separator using the inorganic particles has excellent heat resistance. The inorganic particles may be in the form of particles or fibers. Mixtures of these are also anticipated.

The inorganic materials must be electrochemically stable (not subjected to oxidation and/or reduction at the range of drive voltages). Materials of low density are preferred over higher density materials, as the weight of the battery produced can be reduced.

In one embodiment, the particles or fibers may be surface treated, chemically (such as by etching or functionalization), mechanically, or by irradiation (such as by plasma treatment).

The inorganic particles are nano size. Preferably fibers have diameters below 1 micron. Furthermore, excessively large pores may increase a possibility of internal short circuit being generated during repeated charge/discharge cycles.

The inorganic particles are present in the coating composition at 20 to 95 weight percent, and preferably 20-90 weight percent, based on the total of polymer solids and inorganic particles. When the content of the inorganic materials is less than 20 weight percent, the binder polymer is present in such a large amount as to decrease the interstitial volume formed among the inorganic particles and thus to decrease the pore size and porosity, resulting in degradation in the quality of a battery.

Another example, a reticulated film composite can be used as protector coating, i.e. it exhibits high UV blocking/protection when nano size ZnO or nano-TiO₂ is used.

A reticulated film composite can also be used as catalyst support to provide high surface media for catalytically driven reactions and improve catalyst efficiency. The catalyst can be incorporated into reticulated film or can be deposited on it.

Coating Method

The coating composition is applied onto at least one surface of an electrode by means known in the art, such as by brush, roller, ink jet, dip, knife, gravure, wire rod, squeegee, foam applicator, curtain coating, vacuum coating, slot die, or spraying. The coating is then dried onto the electrode at room temperature, or at an elevated temperature. The final dry coating thickness is from 0.5 to 15 microns, preferably from 1 to 8 microns, and more preferably from 2 to 4 microns in thickness.

The coated electrodes can be used to form an electrochemical device, such as a battery, capacitor, electric double layer capacitor, membrane electrode assembly (MEA) or fuel cell, by means known in the art. A non-aqueous-type battery can be formed by placing a negative electrode and positive electrode on either side of the coating. For example if the cathode is coated then an anode can be placed next to the coating, forming an anode-separator coating cathode assembly.

The coating can be cast on a solid substrate and then removed from the substrate and placed on an electrode or alternatively can be directly cast directly onto electrode.

Aspects of the Invention

Aspect 1: A reticulated coating or film comprising a) a resin and b) nanoparticles wherein the coating or film has a porous structure wherein the porous structure is from 10% to 80% open pores, wherein the resin has a solution viscosity of from about 100 cp to 10,000 cp, preferably from 100 cp to 5000 cp (at 5 wt % in NMP or at 2% water for water solution polymers, at room temperature) wherein the nanoparticles are electronically nonconductive and have a surface area of 1 to 1000 m²/g.

Aspect 2: The reticulated coating or film of aspect 1 wherein the average pore size is less than 500 nm, preferably less than 100 nm, and more preferably less than 50 nm.

Aspect 3: The reticulated coating or film of aspect 1 or aspect 2 wherein the resin is selected from the group consisting of polyvinylidene (PVDF), PVDF-copolymers, poly ethylene-tetrafluoride ethylene (PETFE), polyvinyl fluoride (PVF), poly acrylates, poly methacrylates, poly styrene, poly vinyl alcohol (PVOH), polyesters, polyamides, poly acrylonitrile, poly acrylamide, carboxymethyl cellulose CMC, polyacrylic acids (PAA), polymethacrylic acids (PMAA), and their copolymers and combinations thereof.

Aspect 4: The reticulated coating or film of any one of aspects 1 to 3 wherein the resin comprises Polyvinylidene homopolymer or copolymer.

Aspect 5: The reticulated coating or film of any one of aspects 1 to 3 wherein the resin comprises poly methacrylates.

Aspect 6: The reticulated coating or film of any one of aspects 1 to 3 wherein the resin comprises carboxymethyl cellulose.

Aspect 7: The reticulated coating or film of any one of aspects 1 to 3 wherein the resin comprises polyacrylic acid and/or polymethacrylic acid.

Aspect 8: The reticulated coating or film of any one of aspects 1 to 7 wherein the nanoparticles is selected from the group consisting of alumina, silica, BaTiO₃, CaO, ZnO, bohemite, TiO₂, SiC, ZrO₂, boron silicate, BaSO₄, nano-clays, or mixtures thereof.

Aspect 9: The reticulated coating or film of any one of aspects 1 to 7 wherein the nanoparticles are selected from the group consisting of chopped fibers of aramid fillers and fibers, polyetherether ketone fibers, polyetherketone ketone fibers, PTFE fibers, carbon nano-tubes, and mixture thereof.

Aspect 10: The reticulated coating or film of any one of aspects 1 to 7 wherein the nanoparticles comprise fumed alumina or fumed silica, or fumed zirconia.

Aspect 11: The reticulated coating or film of any one of aspects 1 to 10 wherein the weight percent of polymer to nanoparticles is from 80:20 to 10:90, preferably 70:30 to 20:80.

Aspect 12: The reticulated coating or film of any one of aspects 1 to 11 wherein the nanoparticles have a surface area of from 1 to 700 m²/g, more preferably 1 to 600 m2/g.

Aspect 13: The reticulated coating or film of any one of aspects 1 to 12 wherein the separator coating has a thickness of from 0.05 to 100 microns, preferably from 0.05 to 50 microns, and more preferably from 0.05 to 10 microns.

Aspect 14: The reticulated coating or film of any one of aspects 1 to 13 wherein the nanoparticle size is less than 500 nm preferably less than 200 nanometers.

Aspect 15: The reticulated coating or film of any one of aspects 1 to 13 wherein the nanoparticle size is less than 100 nm.

Aspect 16: A method of making a reticulated coating or film, the method comprising the steps of
(a) providing a resin dissolved in a solvent wherein the polymer has a solution viscosity of from about 100 cp to 10000 cp, preferably from 100 cp to 5000 cp (at 5 wt % in NMP or at 2 wt % in water for water soluble polymers, at room temperature),
(b) providing nanoparticles, wherein the nanoparticles have surface area of 1 to 1000 m²/g,
(c) combining the resin solution and the nanoparticles to produce a slurry wherein the weight percent of polymer to the weight percent of nanoparticle is from 80:20 to 5:95,
(d) casting the slurry to form a coating or film on a substrate,
(e) drying the formed coating or film
   wherein the coating or film after drying has a porous structure wherein the porous structure is from 10% to 80% open pores wherein the slurry exhibits a yield stress of between 50 dyne/cm2 and 5000 dyne/cm2, preferably between 75 to 3000 dyne/cm2, and wherein the solids content of the slurry is from 2 to 30 weight percent solids, preferably between 2 and 20 weight percent solids.

Aspect 17: The method of aspect 16 wherein the average pore size is less than 1000 nanometers

Aspect 18: The method of aspect 16 wherein the average pore size is less than 500 nanometers, and more preferably less than 100 nanometers.

Aspect 19: The method of any one of aspects 16 to 18 wherein the resin is selected from the group consisting of polyvinylidene (PVDF), PVDF-copolymers, poly ethylene-tetrafluoride ethylene (PETFE), polyvinyl fluoride (PVF), poly acrylates, poly methacrylates, poly styrene, poly vinyl alcohol (PVOH), polyesters, polyamides, poly acrylonitrile, poly acrylamide, carboxymethyl cellulose CMC, polyacrylic acids (PAA), polymethacrylic acids (PMAA) and their copolymers and combinations thereof.

Aspect 20: The method of any one of aspects 16 to 18 wherein the resin comprises Polyvinylidene homopolymer or copolymer.

Aspect 21: The method of any one of aspects 16 to 18 wherein the resin comprises poly methacrylates.

Aspect 22: The method of any one of aspects 16 to 18 wherein the resin comprises carboxymethyl cellulose.

Aspect 23: The method of any one of aspects 16 to 18 wherein the resin comprises polyacrylic acid and/or polymethacrylic acid.

Aspect 24: The method of any one of aspects 16 to 23 wherein the nanoparticles are selected from the group consisting of alumina, silica, BaTiO₃, CaO, ZnO, bohemite, TiO₂, SiC, ZrO₂, boron silicate, BaSO₄, nano-clays, or mixtures thereof.

Aspect 25: The method of any one of aspects 16 to 23 wherein the nanoparticles comprise fumed alumina or fumed silica.

Aspect 26: The method of any one of aspects 16 to 23 wherein the nanoparticles are selected from the group consisting of chopped fibers of aramid fillers and fibers, polyetherether ketone fibers, polyetherketone ketone fibers, PTFE fibers, carbon nano-tubes, and mixture thereof.

Aspect 27: The method of any one of aspects 16 to 26 wherein the solvent is selected from the group consisting of water, N-methyl-2-pyrrolidone (NMP), toluene, tetrahydrofuran (THF), acetone and hydrocarbons.

Aspect 28: The method of any one of aspects 16 to 26 wherein the solvent is selected from the group consisting of NMP, water, acetone and combination thereof, preferably NMP.

Aspect 29: The method of any one of aspects 16 to 26 wherein the solvent comprises water.

Aspect 30: The method of any one of aspects 16 to 26 wherein the solvent comprises NMP.

Aspect 31: The method of any one of aspects 16 to 30 wherein the solids content of the slurry formed containing both the solvent and the nanoparticles is from 2 to 30%, preferably from 2 to 15 weight %.

Aspect 32: The method of any one of aspects 16 to 30 wherein the solids content of the slurry formed containing both the solvent and the nanoparticles is from 2 to 12 weight percent.

Aspect 33: The method of any one of aspects 16 to 32 wherein the weight percent of polymer to the weight percent of nanoparticle is from 80:20 to 5:95, preferably 80:20 to 10:90.

Aspect 34: The method of any one of aspects 16 to 32 wherein the weight percent of polymer to the weight percent of nanoparticle is from 70:30 to 20:80,

Aspect 35: The method of any one of aspects 16 to 34 wherein the nanoparticles have a surface area of from 1 to 700 m²/g, more preferably 1 to 600 m2/g.

Aspect 36: The method of any one of aspects 16 to 34 wherein the coating has a thickness of from 0.05 to 100 microns, preferably from 0.05 to 50 microns, and more preferably from 0.05 to 20 microns.

Aspect 37: The method of any one of aspects 16 to 36 wherein the nanoparticle size is less than 500 nm preferably less than 200 nanometers.

Aspect 38: The method of any one of aspects 16 to 36 wherein the nanoparticle size is less than 100 nm.

Aspect 39: The method of any one of aspects 16 to 38 wherein the reticulated film or coating is simultaneously cast directly with the substrate in one step in a wet on wet process.

Aspect 40: The reticulated coating or film made by the method of any one of aspects 16 to 39.

Aspect 41. An article comprising the reticulated coating or film of any one of aspects 1 to 15 wherein the article is selected from the group consisting of a separator in a electrochemical device, a sound adsorbing coating, a filter media or in a high efficiency particulate adsorbing filter such as a HEPA filter.

Aspect 42. An article comprising the reticulated coating or film of any one of aspects 1 to 15 wherein the article comprises a separator in a electrochemical device.

Aspect 43. An article comprising the reticulated coating or film of any one of aspects 1 to 15 wherein the article comprises a high efficiency particulate adsorbing filter such as a HEPA filter.

### Test Methods

Melt viscosity measured according to ASTM method D-3835 measured at 450° F. and 100 sec-1.

Particle size of nano particles can be measured using a Malvern Masturizer 2000 particle size analyzer. The data is reported as weight-average particle size (diameter).

Powder/latex average discrete particle size can be measured using a NICOMP™ 380 submicron particle sizer using laser light scattering. The data is reported as weight-average particle size (diameter).

Density of composite was calculated by dividing the weight of composite over volume of a specific sample. First the composite was cast on an aluminum foil, then a sample having 1.33 cm\hat{ }2 surface area was made by stamp cutting of the cast composite. The thickness of sample was measured with micrometer having accuracy of 0.1 micron. The weight of composite was measured using an analytical balance and subtracted the weight of the aluminum foil. Density of solid material is based on published literature values: i.e. PVDF polymers=1.78 g/cm3, PMMA=1.13 g/cm3, CMC=1.6 g/cm3.

BET specific surface area, pore volume, and pore size distribution of materials can be determined using a QUANTACHROME NOVA-E gas sorption instrument. Nitrogen adsorption and desorption isotherms are generated at 77K. The multi-point Brunauer-Emmett-Teller (BET) nitrogen adsorption method is used to characterize the specific surface area. A Nonlocal Density Functional Theory (NLDFT, N2, 77k, slit pore model) is used to characterize the pore volume and pore size distribution.

Solution viscosity: ASTM 2857

Yield stress back calculation: Brookfield Viscometer DV-III Ultra, spindle CP52 calculation based on the Herschel-Bulkley model equation:

τ = τ° + kDⁿ

| | | |
|---|---|---|
| τ = Shear stress (D/cm2) | k = Consistency index (cP) | n = flow index |
| τ° = Yield stress (D/cm2) | D = Shear rate (1/sec) | |

τ=Shear stress (D/cm2): force tending to cause deformation of a material by slippage along a plane or planes parallel to the imposed stress.
τ°=Yield stress (D/cm2): Yield stress is the amount of stress that an object needs to be permanently deformed or start flowing.
k=Consistency index (cP): related to the nature of the fluid. As the fluid becomes more viscous, consistency index increases.
D=Shear rate (1/sec): Shear rate is the rate of change of velocity at which one layer of fluid passes over an adjacent layer.
n=flow index: Flow behavior of complex fluids is traditionally characterized through the distinction between Newtonian and non-Newtonian fluids based on each their viscosity dependences on the rate of deformation and the change of shear rate.
τ is the shear stress, it needs to be divided by the shear rate to get the viscosity. The calculation would be:

$$\frac{τ° + ( \frac{k}{100} ) {D}^{n}}{D} \times 100 = Viscosity ( cP )$$

k In the table is expressed in Centipoise so it needs to be divided by 100 to get it in D/cm2 and to add it to τ°. To back calculate τ°, the equation becomes

$$τ° = \frac{( Viscosity \times D )}{100} - ( \frac{k}{100} ) {D}^{n}$$

### EXAMPLES

### Example 1

Three different reticulated film composites of PVDF (Kynar HSV-1810) (a PVDF polymer with carboxylic functionality) and fumed alumina using NMP as solvent and at about 8% slurry solids content (by weight). Fumed alumina grade: Fumed Alumina: Aeroxide AluC

| | | | | Density of | calculated | |
|---|---|---|---|---|---|---|
| | Mass of 1.33 | Mass loading | Thickness | Film | Solid density | Porosity |
| | cm2 of coating | (mg/cm2) | (um) | (g/cm3) | (g/cm3) | (%) |
| 50/50 | 6.4 | 0.940 | 10 | 0.940 | 2.45 | 64 |
| | 7.7 | 1.917 | 21 | 0.913 | | |
| | 7.8 | 1.992 | 24 | 0.830 | | |
| 30/70 | 5.97 | 0.617 | 10.5 | 0.587 | 2.89 | 80 |
| (PVDF/Al2O3) | | | | | | |
| 70/30 | 6.15 | 0.752 | 7 | 1.074 | 2.13 | 42 |
| (PVDF/Al2O3) | 6.89 | 1.308 | 10 | 1.308 | | |
| | 8.1 | 2.218 | 17 | 1.305 | | |

This shows the porosity that can be obtained using the method of the invention. % Porosity=[1−(film density/calculated density)]*100. Adjusting the weight ratio of resin to nano particle can be used to change the porosity. High porosity was achieved.

### Example 2

Reticulated film composites made of fumed alumina with PVDF polymer (Kynar HSV-900) and PMMA with RV=1.1. NMP was used as the solvent and a 8% solids content (by weight) of the slurry.

| | Masse of 1.33 | Mass loading | Thickness | Density | Solid density | Porosity |
|---|---|---|---|---|---|---|
| | cm2 of coating | (mg/cm2) | (um) | (g/cm3) | (g/cm3) | (%) |
| 50/50 | 5.9 | 0.564 | 5 | 1.128 | 2.45 | 54 |
| (PVDF/AL2O3) | 7.54 | 1.797 | 15.5 | 1.159 | | |
| | 8.5 | 2.519 | 23 | 1.095 | | |
| 30/70 | 5.66 | 0.383 | 6 | 0.639 | 2.89 | 62 |
| (PVDF/Al2O3) | 6.5 | 1.015 | 6.5 | 1.562 | | |
| 70/30 | 5.95 | 0.602 | 3 | 2.005 | 2.13 | 11 |
| (PVDF/Al2O3) | 6.6 | 1.090 | 6 | 1.817 | | |
| | 7.9 | 2.068 | 11 | 1.880 | | |
| 30/70 | 5.9 | 0.564 | 7 | 0.806 | 1.31 | 42 |
| (PMMA/Al2O3) | 6.89 | 1.308 | 18 | 0.727 | | |

This shows the porosity that can be obtained using the method of the invention. In general, the less resin used provides better porosity. Different resin can be used. In this example both PVDF and PMMA provided a porosity of at least 42%.

### Example 3

Calendaring for reticulated film composites of PVDF (Kynar 1810) and PMMA (RV=1.1) resins using different conductive carbons and fumed alumina. Weight ratio of polymer to nanoparticle was 50:50. NMP was used as the solvent and a 8% solids content (by weight) of the slurry.

| | Thickness (um) | |
|---|---|---|
| | After drying | After |
| | (120° C. for 30 min) | calendaring |
| PVDF + Carbon (SuperP) | 10.5 | 5.5 |
| PVDF + Carbon (Denka 100) | 11 | 6 |
| PVDF + Carbon (Denka 435) | 11 | 6 |
| PVDF + Al2O3 | 12.5 | 4.5 |
| PMMA (R = 1.1) + Carbon | 11.5 | 6.5 |
| (SuperP) | | |
| PMMA (R = 1.1) + Al2O3 | 7 | 3.5 |

PMMA = polymethylmethacrylate

This shows that a reticulated film is formed and that is has porosity.

### Example 4

Effect of temperature on reticulated film composites:

Weight ratio of polymer to nanoparticle was 50:50. NMP was used as the solvent and a 8% solids content (by weight) of the slurry.

| | | Masse of | Mass | | | | |
|---|---|---|---|---|---|---|---|
| | | 1.33 cm2 | loading | Thickness | Density | Expected | Porosity |
| | | of coating | (mg/cm2) | (um) | (g/cm3) | density | (%) |
| 60% | Dried at 80° C. | 6.32 | 0.789 | 11 | 0.718 | 1.96 | 63.4 |
| Denka | Dried at 100° C. | 6.38 | 0.835 | 12 | 0.695 | 1.96 | 64.5 |
| 100 + | Dried at 120° C. | 6.22 | 0.714 | 11 | 0.649 | 1.96 | 66.9 |
| HSV- | Dried at 180° C. | 6.43 | 0.872 | 13 | 0.671 | 1.96 | 65.8 |
| 1810 | | | | | | | |
| 60% | Dried at 80° C. | | | 7.5 | | 1.96 | |
| Denka | Dried at 100° C. | 6.17 | 0.677 | 11.5 | 0.588 | 1.96 | 70.0 |
| 435 + | Dried at 120° C. | 6.11 | 0.632 | 11 | 0.574 | 1.96 | 70.7 |
| HSV- | Dried at 180° C. | 6.2 | 0.699 | 12.5 | 0.559 | 1.96 | 71.4 |
| 1810 | | | | | | | |

This shows generally a greater drying temperature will provide an increase in porosity.

### Example 5

Waterborne process using two different nanoparticles (fumed silica and also nano ZnO) with three different binders (CMC, PAA, and CMC/SBR) NMP was used as the solvent and a 8% solids content (by weight) of the slurry.

| | Mass | | | |
|---|---|---|---|---|
| | Loading | Density | Expected | Porosity |
| | (mg/cm2) | (g/cm3) | Density | (%) |
| SiO₂ + PAA | 0.98 | 0.57 | 1.60 | 64 |
| 50:50 by weight | | | | |
| SiO₂ + CMC + SBR | 0.71 | 0.60 | 1.48 | 60 |
| (50:25:25) | | | | |
| ZnO + CMC | 0.55 | 0.73 | 2.5 | 71 |
| 50:50 | | | | |
| ZnO + CMC + SBR | 0.83 | 1.03 | 1.65 | 37 |
| 50:25:25 | | | | |

Fumed silica grade: Aerosil R9200 and 7200 from Evonik

This shows the porosity that can be obtained using the method of the invention. Various polymers and various nanoparticles can be used.

1. A reticulated porous coating or film comprising a) a resin and b) nanoparticles, wherein the reticulated coating or film has an open porous structure wherein the porous structure is from 10% to 80% open pores, wherein the resin has a solution viscosity of from about 100 cp to 10,000 cp, preferably from 100 cp to 5000 cp (at 5 wt % in NMP or at 2% in water for water solution polymers, at room temperature) wherein the nanoparticles are electronically nonconductive and have a surface area of 1 to 1000 m²/g.

2. The reticulated coating or film of claim 1 wherein the average pore size is less than 500 nm, preferably less than 100 nm, and more preferably less than 50 nm.

3. The reticulated coating or film of claim 1 or claim 2 wherein the resin is selected from the group consisting of polyvinylidene fluoride (PVDF), PVDF-copolymers, poly ethylene-tetrafluoride ethylene (PETFE), polyvinyl fluoride (PVF), poly acrylates, poly methacrylates, poly styrene, poly vinyl alcohol (PVOH), polyesters, polyamides, poly acrylonitrile, poly acrylamide, carboxymethyl cellulose CMC, polyacrylic acids (PAA), poly methacrylic acid and their copolymers and combinations thereof.

4. The reticulated coating or film of any one of claims 1 to 2 wherein the resin comprises polyvinylidene fluoride polymer.

5. The reticulated coating or film of any one of claims 1 to 2 wherein the resin comprises poly acrylates, poly methacrylates polymers.

6. The reticulated coating or film of any one of claims 1 to 2 wherein the resin comprises carboxymethyl cellulose polymer.

7. The reticulated coating or film of any one of claims 1 to 2 wherein the resin comprises polyacrylic acid and or poly methacrylic acid polymer.

8. The reticulated coating or film of any one of claims 1 to 2 wherein the nanoparticles is selected from the group consisting of alumina, zirconia, silica, BaTiO₃, CaO, ZnO, bohemite, TiO₂, SiC, ZrO₂, boron silicate, BaSO₄, nano-clays, or mixtures thereof.

9. The reticulated coating or film of any one of claims 1 to 2 wherein the nanoparticles are selected from the group consisting of chopped fibers of aramid fillers and fibers, polyetherether ketone fibers, polyetherketone ketone fibers, PTFE fibers, carbon nano-tubes, and mixture thereof.

10. The reticulated coating or film of any one of claims 1 to 2 wherein the nanoparticles comprise fumed alumina or fumed silica or combination thereof.

11. The reticulated coating or film of any one of claims 1 to 2 wherein the weight percent of polymer to nanoparticles is from 80:20 to 10:90, preferably 70:30 to 20:80.

12. The reticulated coating or film of claim 11 wherein the nanoparticles have a surface area of from 1 to 700 m²/g, more preferably 1 to 600 m2/g.

13. The reticulated coating or film of any one of claims 1 to 2 wherein the coating has a thickness of from 0.05 to 100 microns, preferably from 0.05 to 50 microns, and more preferably from 2 to 20 microns.

14. The reticulated coating or film of claim 12 wherein the nanoparticle size is less than 500 nm preferably less than 200 nanometers.

15. A method of making a reticulated coating or film, the method comprising the steps of
a) providing a resin dissolved in a solvent wherein the polymer has a solution viscosity of from about 100 cp to 10000 cp, preferably from 100 cp to 5000 cp (at 5 wt % in NMP or at 2 wt % in water for water soluble polymers, at room temperature),
b) providing nanoparticles, wherein the nanoparticles have surface area of 1 to 1000 m²/g,
c) combining the resin solution and the nanoparticles to produce a slurry wherein the weight percent of polymer to the weight percent of nanoparticle is from 80:20 to 5:95,
d) casting the slurry to form a coating or film on a substrate,
e) drying the formed coating or film, and.
wherein the coating or film after drying has a porous structure wherein the porous structure is from 10 vol % to 80 vol % open pores,
wherein the slurry exhibits a yield stress of between 50 dyne/cm2 and 5000 dyne/cm2, preferably between 75 to 3000 dyne/cm2, and wherein the solids content of the slurry is from 2 to 30 weight percent solids, preferably between 2 and 20 weight percent solids.

16. The method of claim 15 wherein the average pore size is less than 1000 nanometers, and more preferably less than 500 nanometers.

17. The method of any one of claims 15 to 16 wherein the resin is selected from the group consisting of Polyvinylidene (PVDF), PVDF-copolymers, poly ethylene-tetrafluoride ethylene (PETFE), polyvinyl fluoride (PVF), poly acrylates, poly methacrylates, poly styrene, poly vinyl alcohol (PVOH), polyesters, polyamides, poly acrylonitrile, poly acrylamide, carboxymethyl cellulose CMC, polyacrylic acids (PAA), and their copolymers and combinations thereof.

18. The method of any one of claims 15 to 16 wherein the resin comprises polyvinylidene homopolymer and/or copolymer.

19. The method of any one of claims 15 to 16 wherein the resin comprises poly methacrylates and/or poly acrylics polymers.

20. The method of any one of claims 15 to 16 wherein the resin comprises carboxymethyl cellulosepolymers.

21. The method of any one of claims 15 to 16 wherein the resin comprises poly methacrylic acid and/or polyacrylic acid polymers.

22. The method of any one of claims 15 to 16 wherein the nanoparticles are selected from the group consisting of alumina, silica, BaTiO3, CaO, ZnO, bohemite, TiO2, SiC, ZrO2, boron silicate, BaSO4, nano-clays, zirconia or mixtures thereof.

23. The method of any one of claims 15 to 16 wherein the nanoparticles comprise fumed alumina or fumed silica or combination thereof.

24. The method of any one of claims 15 to 16 wherein the nanoparticles are selected from the group consisting of chopped fibers of aramid fillers and fibers, polyetherether ketone fibers, polyetherketone ketone fibers, PTFE fibers, carbon nano-tubes, and mixture thereof.

25. The method of any one of claims 15 to 16 wherein the weight percent of polymer to the weight percent of nanoparticle is from 80:20 to 5:95, preferably 80:20 to 10:90.

26. The method of claim 25 wherein the nanoparticles have a surface area of from 1 to 700 m²/g, more preferably 1 to 600 m2/g.

27. The method of any one of claims 15 to 16 wherein the coating has a thickness of from 0.05 to 100 microns, preferably from 0.05 to 50 microns, and more preferably from 2 to 20 microns.

28. The method of claim 26 wherein the nanoparticle size is less than 500 nm preferably less than 200 nanometers.

29. The reticulated coating or film made by the method of any one of claims 15 to 28.

30. The method of any one of claims 15 to 16 wherein the reticulated film or coating is simultaneously cast directly with the substrate in one step in a wet on wet process.

31. An article comprising the reticulated coating or film of claim 3 wherein the article is selected from the group consisting of a separator in a electrochemical device, a sound adsorbing coating, a filter media or in a high efficiency particulate adsorbing filter such as a HEPA filter.

32. An article comprising the reticulated coating or film of claim 3 wherein the article comprises a separator in a electrochemical device.

33. An article comprising the reticulated coating or film of claim 3 wherein the article comprises a high efficiency particulate adsorbing filter such as a HEPA filter.
